(19) United States
(12) Patent Application Publication
(10) Pub. No.: US 2016/0068122 A1
(43) Pub. Date: Mar. 10, 2016

(54) ENERGY HARVESTING MODULE

(71) Applicant: Nissan North America, Inc., Franklin, TN (US)

(72) Inventors: Randall JOHNSON, White Lake, MI (US); Nelson PHAN, Rochester Hills, MI (US); Bhargav SURA, Sterling Heights, MI (US); Quan CAT, Canton, MI (US); John TURNER, White Lake, MI (US); Constance NEWBOUND, Saline, MI (US)

(73) Assignee: Nissan North America, Inc.

(21) Appl. No.: 14/482,530

(22) Filed: Sep. 10, 2014

(51) Int. Cl. B60R 16/03; B60L 11/18; H02K 7/18

(52) U.S. Cl. CPC B60R 16/0307; H02K 7/1892; B60L 11/1824; B60L 2230/22

(57) ABSTRACT

An energy harvesting system for a vehicle includes a vehicle component having an outer surface facing an exterior of the vehicle and an inner surface facing an interior compartment of the vehicle, and an energy harvesting module disposed in the vehicle component. The energy harvesting module includes an accessory battery and first and second energy harvesting devices. The accessory battery is configured to supply power to a vehicle accessory. The first energy harvesting device is electrically coupled to the accessory battery and is configured to harvest ambient energy collected from the exterior of the vehicle. The second energy harvesting device is electrically coupled to the accessory battery and is configured to harvest ambient energy collected from the interior of the vehicle. The energy harvesting module converts the harvested ambient energy to electrical energy.

### BACKGROUND

1. Field of the Invention

The present invention generally relates to an energy harvesting system for a vehicle. More specifically, the present invention relates to an energy harvesting system for a vehicle including an energy harvesting module configured to convert ambient energy to electrical energy and a storage device configured to store and supply electrical energy.

2. Background Information

A battery of an electric vehicle (EV) stores electricity received from an external power source. The stored electricity powers the EV such that the range of the EV is limited by the amount of stored electricity. Supplying power to accessory components of the EV, such as interior lighting, drains the stored electricity, thereby decreasing the remaining battery charge and, thus, the range of the EV. Accordingly, a need exists for an energy harvesting system for a vehicle that harvests and utilizes ambient energy to power vehicle accessories.

### SUMMARY

In view of the state of the known technology, one aspect of the present invention provides an energy harvesting system for a vehicle including a vehicle component having an outer surface facing an exterior of the vehicle and an inner surface facing an interior compartment of the vehicle, and an energy harvesting module disposed in the vehicle component. The energy harvesting module includes an accessory battery and first and second energy harvesting devices. The accessory battery is configured to supply power to a vehicle accessory. The first energy harvesting device is electrically coupled to the accessory battery and is configured to harvest ambient energy collected from the exterior of the vehicle. The second energy harvesting device is electrically coupled to the accessory battery and is configured to harvest ambient energy collected from the interior of the vehicle. The energy harvesting module converts the harvested ambient energy to electrical energy.

Another aspect of the present invention provides an energy harvesting system for an electric vehicle including a vehicle structure and a vehicle component connected to the vehicle structure. The vehicle component has an outer surface facing an exterior of the vehicle and an inner surface facing an interior of the vehicle. An energy harvesting module includes an accessory battery disposed in the vehicle component and is configured to supply power to a vehicle accessory. A first energy harvesting device is disposed in the vehicle component and is electrically coupled to the accessory battery. The first energy harvesting device is configured to harvest ambient energy collected from the exterior of the vehicle. A second energy harvesting device is disposed in the vehicle component and is electrically coupled to the accessory battery. The second energy harvesting device is configured to harvest ambient energy collected from the interior of the vehicle. A third energy harvesting device is disposed externally of the vehicle component and is electrically coupled to the accessory battery. The third energy harvesting device is configured to harvest ambient energy collected from the interior of the vehicle. The energy harvesting module is configured to convert the harvested ambient energy to electrical energy.

### BRIEF DESCRIPTION OF THE DRAWINGS

Referring now to the attached drawings which form a part of this original

### DISCLOSURE

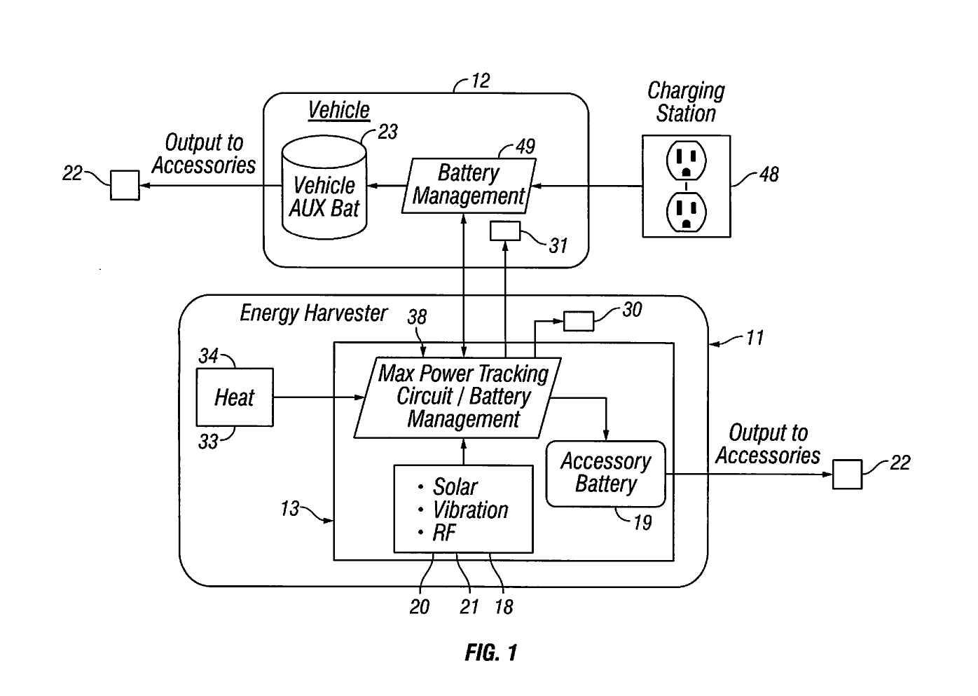

FIG. 1 is a schematic diagram of an energy harvesting system in accordance with an exemplary embodiment of the present invention;

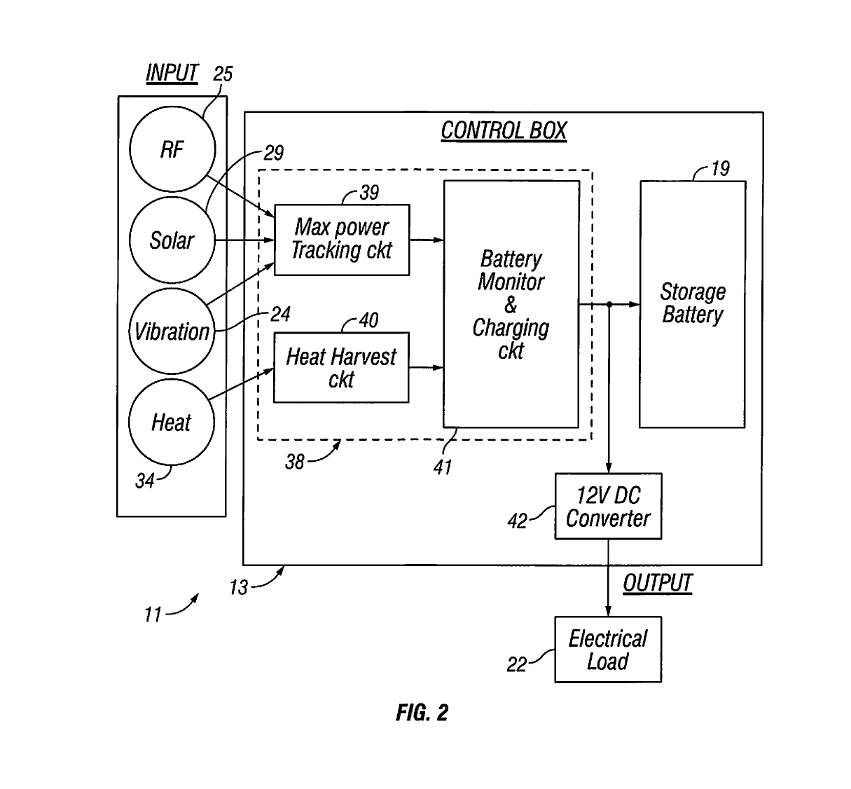

FIG. 2 is a circuit diagram of the energy harvesting system of FIG. 1;

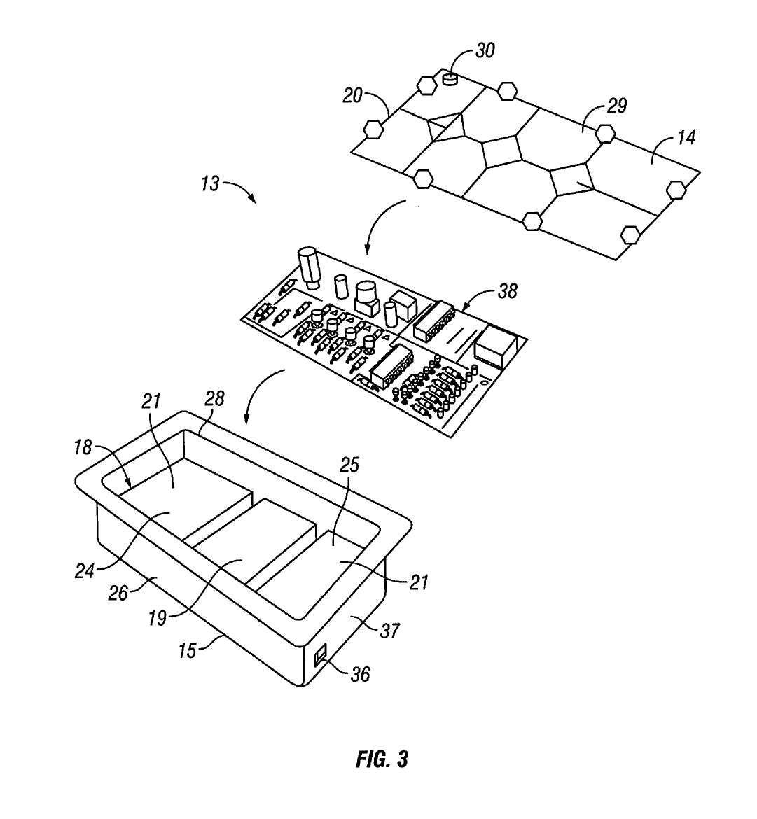

FIG. 3 is an exploded perspective view of an energy harvesting module of FIG. 1;

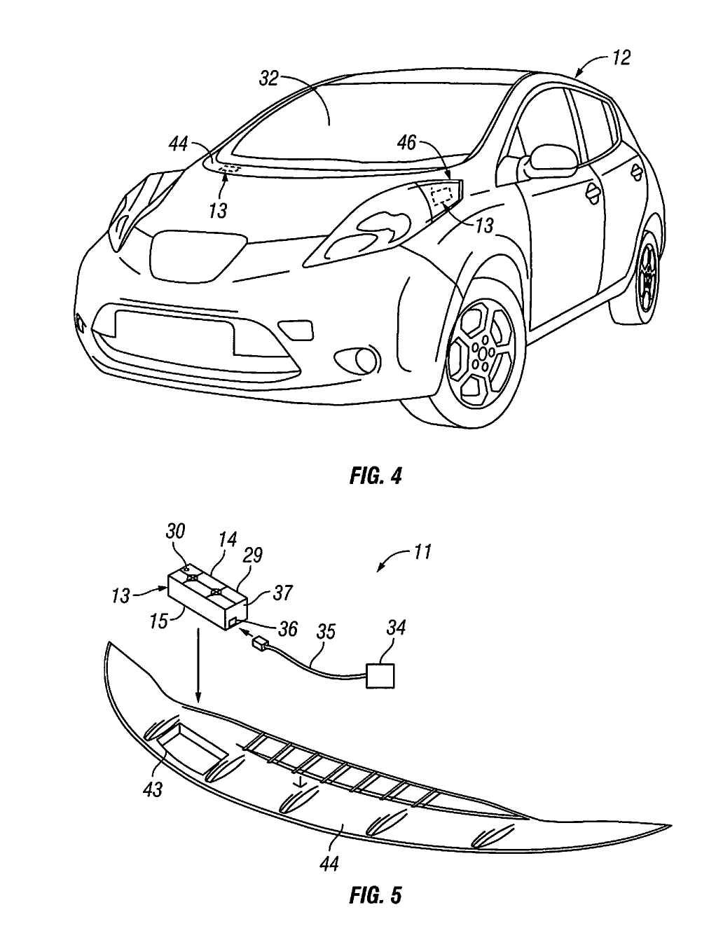

FIG. 4 is a perspective view of a vehicle including the energy harvesting system of FIG. 1;

FIG. 5 is an exploded perspective view of the energy harvesting module of FIG. 1 disposed in a cowl cover of a vehicle;

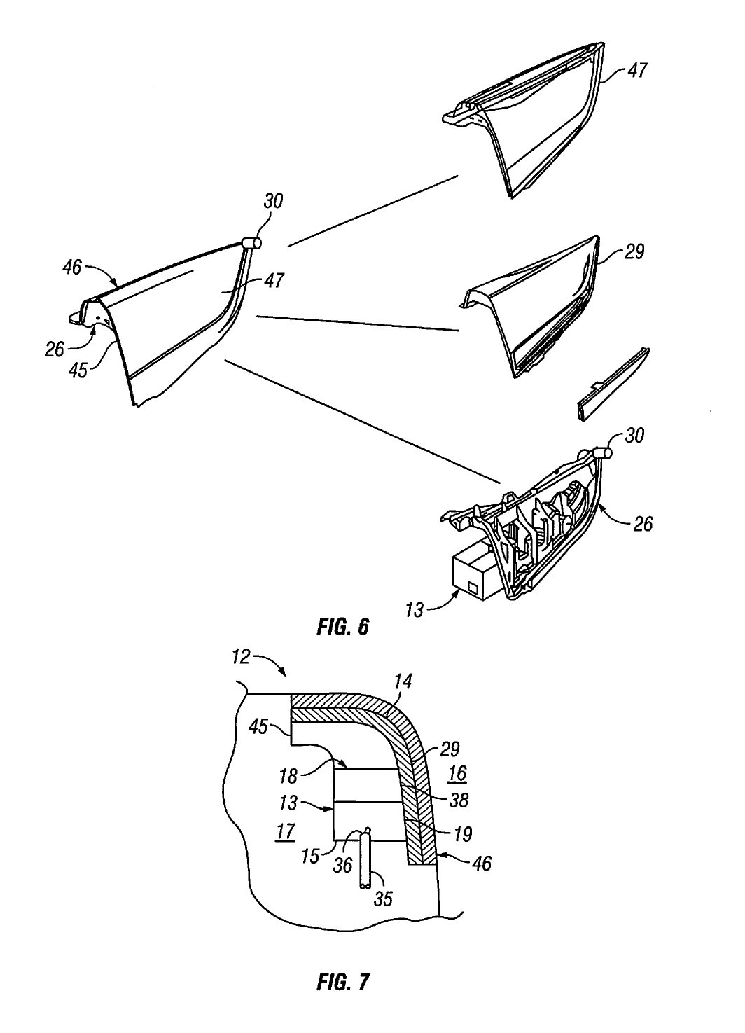

FIG. 6 is an exploded perspective view of the energy harvesting module disposed in a lamp assembly of a vehicle; and

FIG. 7 is an elevation view in cross-section of the energy harvesting module of FIG. 6 disposed in the lamp assembly of the vehicle.

### DETAILED DESCRIPTION OF EXEMPLARY EMBODIMENTS

Selected exemplary embodiments will now be explained with reference to the drawings. It will be apparent to those skilled in the art from this disclosure that the following descriptions of the exemplary embodiments are provided for illustration only and not for the purpose of limiting the invention as defined by the appended claims and their equivalents.

Referring to FIGS. 1-7, an energy harvesting system 11 for a vehicle 12 includes a vehicle component 13 having an outer surface 14 facing an exterior 16 of the vehicle 12 and an inner surface 15 facing an interior compartment 17 of the vehicle 12. An energy harvesting module 18 is disposed in the vehicle component 13. The energy harvesting module 18 includes an accessory battery 19 and first and second energy harvesting devices 20 and 21. The accessory battery 19 is configured to supply power to a vehicle accessory 22. The first energy harvesting device 20 is electrically coupled to the accessory battery 19 and is configured to harvest ambient energy collected from the exterior 16 of the vehicle 12. The second energy harvesting device 21 is electrically coupled to the accessory battery 19 and is configured to harvest ambient energy collected from the interior 17 of the vehicle 12. The energy harvesting module 18 converts the harvested ambient energy to electrical energy.

The vehicle 12 is preferably an electric vehicle, as shown in FIG. 4. Power is supplied to an electric motor by a rechargeable main battery (not shown). In addition to the main battery, the electric vehicle 12 has an auxiliary battery 23 to supply power to vehicle accessories, such as WiFi, a charger, interior lighting and accent lighting. Other possible accessories that can be powered by the auxiliary battery include an audio system, a supplemental restraint system, headlights and windshield wipers. By powering accessories with the auxiliary battery 23, the main battery does not have to supply power to the accessories such that the main battery charge lasts longer to extend the range of the vehicle.

As shown in FIGS. 1-3, the energy harvesting module 18 includes an accessory battery 19, a first energy harvesting device 20 and a second energy harvesting device 21 disposed in the vehicle component 13.

As shown in FIG. 3, the outer surface 14 and the inner surface 15 of the vehicle component 13 define an enclosure 26 in which the energy harvesting module 18 is disposed. As shown in FIG. 3, a plurality of walls 27 extends upwardly from the inner surface 15 to define an aperture 28 in the vehicle component 13. As shown in FIG. 7, the outer surface 14 of the vehicle component 13 faces the exterior 16 of the vehicle 12. The inner surface 15 of the vehicle component 13 faces the interior compartment 17 of the vehicle 12.

The first energy harvesting device 20 includes a solar panel 29. As shown in FIG. 5, the solar panel 29 can be disposed in the aperture 28 of the enclosure 26. Alternatively, as shown in FIG. 7, the solar panel 29 forms the outer surface 14 of the vehicle component 13. The solar panel 29 is exposed to the exterior 16 of the vehicle 12 to harvest solar energy. The solar panel 29 is electrically coupled to the accessory battery 19, as shown in FIGS. 1 and 2, such that harvested solar energy can be stored therein as electrical energy.

The second energy harvesting device 21 can include a vibration harvesting module 24 electrically coupled to the accessory battery 19 and configured to harvest vibration energy. The vibration harvesting module 24 can be any suitable energy harvesting device configured to harvest vibration energy of the vehicle. The vibration harvesting module 24 is electrically coupled to the accessory battery 19, as shown in FIGS. 1 and 2.

In addition to or instead of the vibration harvesting module, the second energy harvesting device 21 can include a radio frequency harvesting module 25. The radio frequency harvesting module 25 is electrically coupled to the accessory battery 19 and configured to harvest radio frequency energy. The radio frequency harvesting module 25 can be any suitable energy harvesting device configured to harvest radio frequency energy, such as RF energy broadcast by a radio transmitter.

A third energy harvesting device 33 includes a heat harvesting module 34 electrically coupled to the accessory battery 19 and configured to harvest heat energy. The heat harvesting module 34 is disposed externally of the vehicle component 13, as shown in FIG. 5, and within the interior compartment 17 of the vehicle 12. The heat harvesting module 34 is mounted to or proximate a heat generating component, such as the electric motor, disposed in the interior compartment 17 of the vehicle 12 to harvest ambient heat generated by the heat generating component. As shown in FIGS. 5 and 7, a cable 35 electrically couples the heat harvesting module 34 to the accessory battery 19. An opening 36 in a surface 37 of the vehicle component 13 receives the cable 35, thereby electrically coupling the heat harvesting module to the accessory battery of the vehicle component 13. The opening 36 can be disposed in any suitable surface 37 of the vehicle component 13. The heat harvesting module 34 is configured to convert the harvested heat to electrical energy.

A circuit board 38 is electrically coupled to the accessory battery 19, as shown in FIGS. 1 and 3. The circuit board 38 includes a maximum power tracking circuit 39, a heat harvesting circuit 40 and a battery management circuit 41, as shown in FIG. 2, configured to manage electrical energy supplied by the accessory battery 19 and electrical energy usage by accessories 22 electrically connected to the accessory battery.

The maximum power tracking circuit 39 monitors the harvested energy from each of the inputs (the vibration harvesting module 24, the radio frequency harvesting module 25 and the solar panel 29) to more efficiently supply power to the accessories 22. When the harvested energy from the inputs is insufficient to power the accessories, the maximum power tracking circuit can supply the required electrical power to the accessories from the accessory battery 19, thereby ensuring proper operation of the accessories.

The heat harvesting circuit 40 monitors the harvested energy from the heat harvesting module 34 to more efficiently supply power to the accessories 22. When the harvested energy from the heat harvesting module 34 is insufficient to power the accessories, the maximum power tracking circuit can supply the required electrical power to the accessories from the accessory battery 19, thereby ensuring proper operation of the accessories.

The battery monitor and charging circuit 41 monitors the charge level of the accessory battery 19 disposed in the energy harvesting module 18 of the vehicle component 13. Harvested energy is directed to the accessory battery 19 to recharge the accessory battery when the battery monitor and charging circuit 41 determines the power level has decreased below a predetermined level.

A first indicator light 30 is disposed on the vehicle component to indicate when energy is being harvested, as shown in FIGS. 1 and 3. The first indicator light 30 is exposed to and visible from the exterior of the vehicle component 13. In addition to or instead of the first indicator light 30, a second indicator light 31, as shown in FIG. 1, can be disposed remotely of the vehicle component 13. The second indicator light 31 is exposed to and visible from a passenger compartment 32 (FIG. 3) of the vehicle 12. The indicator lights 30 and 31 are electrically coupled to the energy harvesting module 18 such that the indicator lights are illuminated when the energy harvesting module 18 is harvesting energy.

The vehicle component 13 includes a converter 42, such as a 12V DC converter, to convert the harvested electrical energy to electrical power usable with a conventional 12V electrical system.

In an exemplary embodiment shown in FIGS. 3-5, the vehicle component 13 is disposed in a cavity 43 in a cowl cover 44 of the vehicle 12. The vehicle component 13 can be secured within the cavity 43 in any suitable manner. The vehicle component 13 can also be defined by surfaces of the cowl cover 44 itself. The enclosure 26 of the vehicle component 13 receives the vibration harvesting module 24, the RF harvesting module 25 and the accessory battery 19. The solar panel 29 is disposed in the aperture 28 in the enclosure 26 to form the outer surface 14 of the vehicle component 13 (e.g., the cowl cover 44). The vibration harvesting module 24, the RF harvesting module 25 and the accessory battery 19 are disposed adjacent a first surface of the circuit board 38, and the solar panel 29 is disposed on the opposite surface of the circuit board 38. The vibration harvesting module 24, the RF harvesting module 25, the solar panel 29 and the circuit board 38 are electrically coupled to the accessory battery 19. By forming the outer surface 14 of the vehicle component 13, the solar panel 29 is exposed to the exterior of the vehicle, thereby facilitating harvesting of solar power. The indicator light 30 is mounted to the solar panel 29 such that the indicator light is visible from the exterior of the vehicle component 13 when illuminated.

The heat harvesting module 34 is electrically coupled to the accessory battery 19 through the circuit board 38. The opening 36 in the enclosure 26 receives the cable 35, thereby electrically coupling the heat harvesting module 34 to the circuit board 38. The heat harvesting element 34 is mounted to or proximate to a heat source disposed in the interior compartment 17 of the vehicle 12, such as a high temperature heat source of the drivetrain.

In another exemplary embodiment shown in FIGS. 6 and 7, the vehicle component 13 is disposed in a cavity 45 of a lamp assembly 46. The lamp assembly 46 includes a transparent lens 47 behind which the vehicle component 13 is mounted. Similar to the embodiment described above, the vehicle component 13 can be defined by surfaces integral to the lamp assembly 46. The vibration harvesting module 24, the RF harvesting module 25 and the accessory battery 19 are disposed in an enclosure 26 secured to the transparent lens 47. The solar panel 29 is disposed between the enclosure 26 and the transparent lens 47, such that the solar panel 29 is exposed to the exterior 16 of the vehicle 12 through the transparent lens 47 to harvest solar power. The cable 35 passes through the opening 36 in the enclosure 26 to connect the heat harvesting module 34 (FIG. 1) thereto. The indicator light 30 is connected to the enclosure 26 and is illuminated when ambient energy is being harvested. The illuminated indicator light 30 is visible through the solar panel 29 and the transparent lens 47. Alternatively, the indicator light 30 can be connected to the solar panel.

The vehicle 12 is charged by a conventional charging station 48, as shown in FIG. 1. The vehicle auxiliary battery 23 and the accessory battery 19 are charged to full capacity when charging the main battery of the vehicle 12. A battery management circuit 49 of the vehicle 12 monitors the power supply from the vehicle component 13 through a battery monitoring and charging circuit 41 of the vehicle component 13. When the power supply of the vehicle component 13 is insufficient, the battery management circuit 49 causes power to be supplied to the accessories from the vehicle auxiliary battery 19. The vehicle battery management circuit 49 causes excess power harvested by the energy harvesting system 11 to be supplied to the vehicle auxiliary battery 23, as shown in FIG. 1.

As shown in FIG. 2, the power harvested by the vibration harvesting module 24, the RF harvesting module 25, the solar panel 29 and the heat harvesting module 34 can be directly supplied to the accessories through the maximum power tracking and heat harvesting circuits 39 and 40. The harvested power is converted by the converter 42 to 12V DC power and supplied to the accessories 22. The battery monitor and charging circuit 41 can supplement such power with power from the accessory battery 19 as required.

The indicator light 30 is illuminated when energy is being harvested by the vehicle component 13. As shown in FIGS. 1 and 4, the indicator light 31 can be disposed in the passenger compartment 32 to be visible to vehicle occupants when illuminated.

Accordingly, the energy harvesting system 11 in accordance with the exemplary embodiments of the present invention harvests and utilizes ambient energy to power vehicle accessories, thereby increasing the power available from the main battery to increase the vehicle range.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. An energy harvesting system for a vehicle, comprising:
a vehicle component having an outer surface facing an exterior of the vehicle and an inner surface facing an interior compartment of the vehicle; and
an energy harvesting module disposed in the vehicle component, the energy harvesting module including
an accessory battery configured to supply power to a vehicle accessory;
a first energy harvesting device electrically coupled to the accessory battery and configured to harvest ambient energy collected from the exterior of the vehicle; and
a second energy harvesting device electrically coupled to the accessory battery and configured to harvest ambient energy collected from the interior of the vehicle,
the energy harvesting module converting the harvested ambient energy to electrical energy.

2. The energy harvesting system for a vehicle according to claim 1, wherein
the first energy harvesting device comprises a solar panel electrically coupled to the accessory battery and configured to harvest solar energy.

3. The energy harvesting system for a vehicle according to claim 2, wherein
the solar panel is exposed to the exterior of the vehicle through an aperture in the vehicle component.

4. The energy harvesting system for a vehicle according to claim 1, wherein
the second energy harvesting device comprises a vibration harvesting module electrically coupled to the accessory battery and configured to harvest vibration energy.

5. The energy harvesting system for a vehicle according to claim 1, wherein
the second energy harvesting device comprises a radio frequency harvesting module electrically coupled to the accessory battery and configured to harvest radio frequency energy.

6. The energy harvesting system for a vehicle according to claim 1, further comprising
a heat harvesting device electrically coupled to the accessory battery by a cable passing through an aperture in a surface of the vehicle component, the heat harvesting device being configured to capture heat and to convert the harvested heat to electrical energy.

7. The energy harvesting system for a vehicle according to claim 6, wherein
the heat harvesting device is disposed externally of the vehicle component within the interior compartment of the vehicle and fixed to a heat generating component.

8. The energy harvesting system for a vehicle according to claim 1, further comprising
a circuit board electrically coupled to the accessory battery and configured to manage electrical energy supplied by the accessory battery and electrical energy usage by components electrically connected to the accessory battery.

9. The energy harvesting system for a vehicle according to claim 1, wherein
an indicator light is disposed on the vehicle component to indicate when energy is being harvested, the indicator light being exposed to and visible from the exterior of the vehicle component.

10. The energy harvesting system for a vehicle according to claim 1, wherein
an indicator light is disposed remotely from the vehicle component to indicate when energy is being harvested, the indicator light being exposed to and visible from a passenger compartment of the vehicle.

11. The energy harvesting system for a vehicle according to claim 1, wherein
a solar panel disposed externally of the vehicle component and electrically coupled to the accessory battery.

12. An energy harvesting system for an electric vehicle, comprising:
a vehicle structure;
a vehicle component connected to the vehicle structure, the vehicle component having an outer surface facing an exterior of the vehicle and an inner surface facing an interior of the vehicle;
an energy harvesting module including
an accessory battery disposed in the vehicle component and configured to supply power to a vehicle accessory;
a first energy harvesting device disposed in the vehicle component and electrically coupled to the accessory battery, the first energy harvesting device being configured to harvest ambient energy collected from the exterior of the vehicle;
a second energy harvesting device disposed in the vehicle component and electrically coupled to the accessory battery, the second energy harvesting device being configured to harvest ambient energy collected from the interior of the vehicle; and
a third energy harvesting device disposed externally of the vehicle component and electrically coupled to the accessory battery, the third energy harvesting device being configured to harvest ambient energy collected from the interior of the vehicle,
the energy harvesting module being configured to convert the harvested ambient energy to electrical energy.

13. The energy harvesting system for an electric vehicle according to claim 12, wherein
the vehicle structure comprises a cowl cover of the vehicle.

14. The energy harvesting system for an electric vehicle according to claim 12, wherein
the energy harvesting module is electrically coupled to the main battery of the vehicle.

15. The energy harvesting system for an electric vehicle according to claim 14, wherein
the accessory battery of the energy harvesting module is charged when the main battery is electrically connected to an external power source.

16. The energy harvesting system for an electric vehicle according to claim 12, wherein
the first energy harvesting device comprises a solar panel electrically coupled to the accessory battery and configured to harvest solar energy, the solar panel being exposed to the exterior of the vehicle through an aperture in the vehicle component.

17. The energy harvesting system for an electric vehicle according to claim 16, wherein
the third energy harvesting device comprises a heat harvesting device electrically coupled to the accessory battery by a cable passing through an aperture in a surface of the vehicle component, the heat harvesting device being configured to harvest heat.

18. The energy harvesting system for an electric vehicle according to claim 16, wherein
the vehicle component comprises a headlamp, the solar panel being disposed behind a transparent lens of the headlamp.

19. The energy harvesting system for an electric vehicle according to claim 12, wherein
an indicator light is disposed on the vehicle component to indicate when energy is being harvested, the indicator light being exposed to and visible from the exterior of the vehicle component.

20. The energy harvesting system for an electric vehicle according to claim 12, wherein
an indicator light is disposed remotely from the vehicle component to indicate when energy is being harvested, the indicator light being exposed to and visible from the exterior of the vehicle.
